(19) United States
(12) Patent Application Publication
(10) Pub. No.: US 2018/0331526 A1
(43) Pub. Date: Nov. 15, 2018

(54) ELECTRICAL CEILING BOX WITH HANGING ELEMENT FOR CATCHING HOLD OF FAN OR FIXTURE DURING INSTALLATION

(71) Applicant: Mingrong Zhao, Ottawa (CA)

(72) Inventor: Mingrong Zhao, Ottawa (CA)

(21) Appl. No.: 15/882,519

(22) Filed: Jan. 29, 2018

(30) Foreign Application Priority Data
Jan. 30, 2017 (CA) 2956440

(51) Int. Cl. H02G 7/05; H02G 3/08; H02G 3/20; F04D 25/08; F21V 21/03

(52) U.S. Cl. CPC H02G 7/05; H02G 3/081; F21V 21/03; F04D 25/088; H02G 3/20

(57) ABSTRACT

A ceiling box has one or more than one additional hanging element so electricians could hang up light features or ceiling fans on it to free their hands for connecting wires.

### CROSS-REFERENCE TO RELATED APPLICATIONS

### Application Number 2 956 440

### Filing Date 2017 Jan. 30

Filing country Canadian Intellectual Property Office

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

The present invention is in the technical field of electrical equipment. More particularly, the present invention is in the technical field of electrical junction boxes. More particularly, the present invention is in the technical field of electrical ceiling boxes.

### BRIEF SUMMARY OF THE INVENTION

The invention is a ceiling box having at least one additional hanging element. Electricians will be able to hang up light fixtures or ceiling fans on it before they connect wires. Thus those tools don't need to be held by hands during the installation; also have less chance to be damaged by accidentally dropping.

### BRIEF DESCRIPTION OF THE SEVERAL VIEWS OF THE DRAWINGS

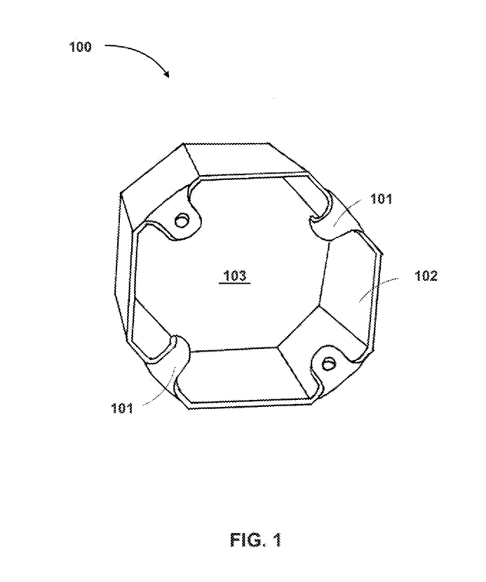

1. FIG. 1 shows a single view of an embodiment having additional hanging elements extended from the open end of ceiling box made by metallic or other similar materials.

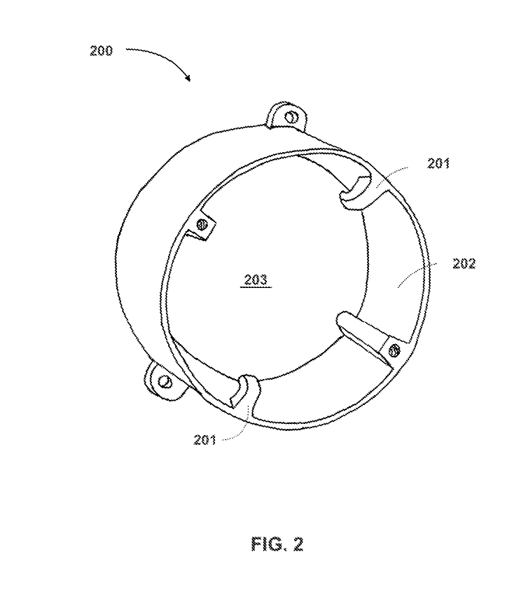

2. FIG. 2 shows a single view of an embodiment having additional hanging elements extended from the open end of ceiling box made by non metallic material.

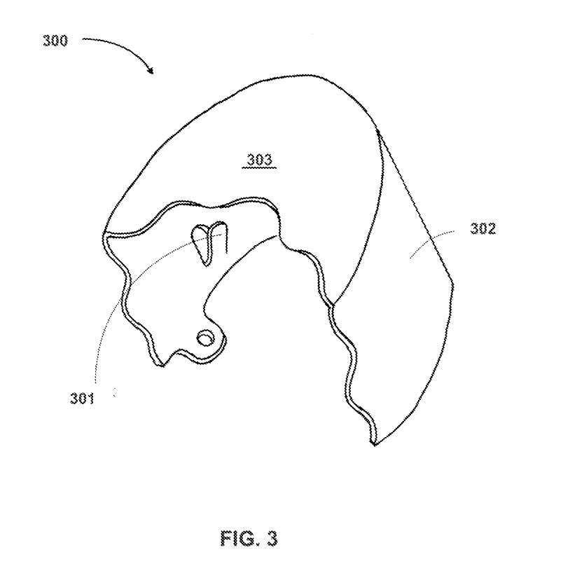

3. FIG. 3 shows a single view of an embodiment having a hanging element which front part was omitted from drawing so that people are able to see the hanging element clearly.

### DETAILED DESCRIPTION OF THE INVENTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “comprising,” or “having” and variations thereof herein is meant to encompass the items listed thereafter and equivalents thereof as well as additional items. Unless limited otherwise, the term “attached” or “extended” and variations thereof herein are used broadly and encompass direct and indirect connections, couplings, and mountings. In addition, the term variations thereof are not restricted to physical or mechanical connections or couplings.
1. FIG. 1 shows a perspective view of an embodiment 100, mainly having a top portion 103, a side portion 102 and two hanging elements 101 which extended from the open end of side portion 102. The open end of side portion 102 is the opposite end to the top portion 103.
   The hanging element 101 provides a feature allowing electricians to hang up light features or ceiling fans on it to free their hands. Strings may be needed for connecting light features or ceiling fans to hanging element 101. After light features or ceiling fans are hung up on the hanging element 101, electricians will have two hands free to connect wires.
   The said embodiment 101 is more suitable to ceiling boxes made by metallic materials. The size of the hanging element 101 in the drawing is only for drawing purpose. The actual real size could be smaller or larger. The shape of hanging element 101 could be any kind of variations according to manufacturing purposes. The hanging element 101 also could be relocated to any preferable place according to manufacturing purposes. There is one or more than one hanging element 101 per ceiling box.
2. FIG. 2 shows a perspective view of an embodiment 200, mainly having a top portion 203, a side portion 202 and two hanging elements 201 which extended from the open end of side portion 202. The open end of side portion 202 is the opposite end to the top portion 203.
   The hanging element 201 provides a feature allowing electricians to hang up light features or ceiling fans on it to free their hands. Strings may be needed for connecting light features or ceiling fans to hanging element 201. After light features or ceiling fans are hung up on the hanging element 201, electricians will have two hands free to connect wires.
   The said embodiment 201 is more suitable to ceiling boxes made by non-metallic materials. The size of the hanging element 201 in the drawing is only for drawing purpose. The actual real size could be smaller or larger. The shape of hanging element 201 could be any kind of variations according to manufacturing purposes. The hanging element 201 also could be relocated to any preferable place according to manufacturing purposes. There is one or more than one hanging element 201 per ceiling box.
3. FIG. 3 shows a perspective view of an embodiment 300, mainly having a top portion 303, a side portion 302 and a hanging element 301 which is close to the open end of side portion 302. The open end of side portion 302 is the opposite end to the top portion 303. The front part of ceiling box is omitted from drawing so that people are able to see the hanging element 301 clearly. Refer to FIG. 3, the hanging element 301 originally is part of the side portion 302.
   The hanging element 301 provides a feature allowing electricians to hang up light features or ceiling fans on it to free their hands. Strings may be needed for connecting light features or ceiling fans to hanging element 301. After light features or ceiling fans are hung up on the hanging element 301, electricians will have two hands free to connect wires.
   The size of the hanging element 301 in the drawing is only for drawing purpose. The actual real size could be smaller or larger. The shape of hanging element 301 could be any kind of variations according to manufacturing purposes. The hanging element 301 also could be relocated to any preferable place according to manufacturing purposes. There is one or more than one hanging element 301 per ceiling box.

It is to be understood that the hanging element also could be an additional item attached to ceiling boxes. For example, a metallic hook screwed into a ceiling box.

1. An electrical ceiling box having at least one hanging element. Said hanging element allows electricians hang up light features or ceiling fans on it. Mainly comprising: a top portion having a perimeter, a side portion extending substantially perpendicularly from said perimeter of said top portion, said side portion and said top portion forming a main cavity with an open end; and said hanging element extending from said top or side portion.
a. An electrical ceiling box to claim 1 wherein said hanging element positioning is preferably near the open end of said side portion.
b. An electrical ceiling box to claim 1 wherein said hanging element extending into said main cavity, said hanging element making said new feature for catching hold of.
c. An electrical ceiling box to claim 1 wherein said hanging element and said side portion are integrally connected to form a one-piece unitary member, or said hanging element as additional part attached to said ceiling box.
d. An electrical ceiling box to claim 1 wherein said hanging element having selective shape and size, preferably extending into the centre of said main cavity and bend toward said top portion.
e. An electrical ceiling box to claim 1 wherein said electric ceiling box having one or more than one said hanging element.
